(19) United States
(12) Patent Application Publication
(10) Pub. No.: US 2008/0165400 A1
(43) Pub. Date: Jul. 10, 2008

(54) Holographic Optical Interleave System and Method

(75) Inventor: Jonathan W. Ellis, Austin, TX (US)

Correspondence Address: ANDERSON LAW GROUP, PLLC, 9600 GREAT HILLS TRAIL, 150W, AUSTIN, TX, 78759, US

(73) Assignee: Advanced Communication Concepts, Austin, TX (US)

(21) Appl. No.: 11/621,992

(22) Filed: Jan. 10, 2007

(51) Int. Cl. G02B 5/32

(52) U.S. Cl. 359/15; 359/1

(57) ABSTRACT

A method and system for optical interconnections with backplanes, cache/memory, chip/die stacks, and mass storage in a supercomputing system. The method includes, but is not limited to, matching a plurality of transmitters to a plurality of receivers to a predetermined phase of an optical signal via a plurality of transmit holographic optical elements and a plurality of receive holographic optical elements; organizing the plurality of transmitters and the plurality of receivers to receive the optical signal via a reflective medium; and modulating the optical signal via the reflective medium from each transmit holographic optical element tuned to the associated receive holographic optical element.

### TECHNICAL FIELD

The present invention relates to holographic optical interleaving of data.

### BACKGROUND OF THE INVENTION

A backplane interconnect system can include a combination of expansion slots, expansion cards, and a bus system. The expansion slots can be connected to computer circuitry, such as a microprocessor, through a bus to enable a computing system to communicate with different devices, such as modems, digital cameras, and drives. Expansion cards facilitate communication via expansion slots. The bus system associated with backplane interconnection system connects power, data, and control lines to the expansion cards in order to facilitate communication between the expansion cards and other PC circuitry.

The need to increase backplane aggregate bandwidth, cache/memory access and cycle times, mass storage data transfer speeds, chip-to-chip data transfers, intra-chip/chip stack interconnections, and inter-node/module bandwidth requires extraordinary improvements to close the gap between a central processing unit (CPU) and a supercomputing system. Conventionally, increases in data transfer rate are accomplished by either increasing the operational frequency of the individual expansion boards, increasing the number of lines associated with a bus, or by utilizing expansion cards for optical communication with an additional expansion card associated with the interconnection system. However, increases in data transfer rates of backplane interconnection systems create crosstalk, noise, degradation in signal integrity, and operational limitations on connectors.

One approach toward increasing the data transfer rates was to control the impedance associated with the bus lines, as discussed in U.S. Pat. No. 6,081,430, La Rue.

In U.S. Pat. No. 6,055,099, Webb teaches an optical backplane with an array of lasers in optical communication with a lens relay system. The lens relay includes a series of coaxially aligned lenses which are spaced apart along a planar substrate and form duplicate images of an optical array at the backplane interconnection's input. The output ports are located at different points along the interconnection system.

In U.S. Pat. No. 5,832,147, Yeh et al. discloses an optical backplane interconnect system employing holographic optical elements (HOEs). A plurality of circuit boards (CBs) and a plurality of integrated circuit chips provide the means to facilitate communication within the backplane interconnection system. Each CB has at least an optically transparent substrate (OTS) mate parallel to the CB. On another OTS mate, two HOEs receive and direct at least part of a light beam received to a detector on a corresponding CB via free space within the circuit board holder or reflection within the OTS mate. However, Yeh's invention limits the number of optical channels due to the difficulty in achieving discrimination between optical free space signals and requires a plurality of CBs and a plurality of integrated circuit chips to facilitate communication within the backplane interconnection system.

In U.S. Pat. No. 6,452,700 B1, Mays, Jr., discloses an optical backplane interconnect system with holographic optical elements (HOEs), that allows specific wavelengths and a certain polarization of optical energy to pass through a lens, while diffracting all other wavelengths and polarization of optical energy away from an optical detector. Mays's invention requires a plurality of expansion cards that are positioned to facilitate communication between an optical source and optical detector via HOEs to filter and refract the optical energy that passes through the lens. What is needed, therefore, is a single technology that increases backplane aggregate bandwidth, and increases cache/memory access and cycle times, mass storage data transfer speeds, chip-to-chip data transfers, intra-chip and chip stack interconnections, and inter-node and module bandwidth, while avoiding cross talk and employing free space without the need for a plurality of expansion cards.

### SUMMARY

Provided is an optical backplane interconnection system, one embodiment of which features a plurality of transmitters and receivers employing holographic optical elements (HOEs) that filter and refract optical channels of communication via a reflective medium without the use of additional expansion cards. A plurality of transmitters are matched with a plurality of receivers to a predetermined phase of an optical signal via a plurality of transmit HOEs and a plurality of receive HOEs. Each transmit HOE is tuned to an associated received HOE, which allows the received HOE to sense the optical signal from the transmit HOE. The plurality of receivers detects the optical signal from the plurality of transmitters via a reflective medium. The HOEs are formed to limit the optical signal passing through and filter of any unwanted characteristics. Thus, the use of a reflective medium allows the computer backplane to employ free space by modulating and directing the optical signal from each transmit HOE tuned to the associated received HOE without requiring the use of a plurality of expansion cards.

In a second embodiment, each HOE is associated with a transmitter/receiver pair and has holographic transforms that are at least substantially similar to the holographic transform associated with the remaining HOE pair. A number of optical channels can be increased so that hundreds of optical channels may facilitate communication between the transmitter/receiver pair tuned to the associated HOE pair and a reflective medium without using additional expansion cards.

In a third embodiment, each HOE reads from a plurality of memory modules that are time offset & interleaved, with bits collected by the Holographic Optical Interleave (HOI) based “local bus” onto unit words at a plurality of memory chip clock rates.

In a fourth embodiment, each HOE is etched or filmed on die for signal isolation on a semiconductor wafer. The light emitsthe elements via the die to transfer a signal. Another light detects the elements on die to receive the signal to allow the HOI to transfer the technology to semiconductor manufacturers.

In a fifth embodiment, HOI acts an interface for mass storage. The HOI interface implements, i.e., integrated controller chips, SCSI controller card, and chip scale controller integration.

In addition to the foregoing, various other methods and/or transferable device aspects are set forth and described in the text (e.g., claims and/or detailed description) and/or drawings of the application.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject described herein will become apparent in the text set forth herein.

### BRIEF DESCRIPTION OF THE DRAWINGS

A better understanding of the subject matter of the application can be obtained when the following detailed description of the disclosed embodiments is considered in conjunction with the following drawings, in which:

FIG. 1A is a simplified plan view of the Holographic Optical Interleave Memory employing free space in accordance with an embodiment of the present invention;

FIG. 1B is a top view of VCSEL drivers and pin diode receivers with free space optical channels in accordance with an embodiment of the present invention;

FIG. 2A and FIG. 2B represent a flow diagram illustrating a method for receiving the optical signal in accordance with an embodiment of the present invention;

FIG. 3 is a simplified plan view of HOI's application to Cache/Memory in accordance with an embodiment of the present invention;

FIG. 4 is a simplified plan view of HOI's application to Cache/Memory with multiplexers, optical pulses, and a volume hologram in accordance with an embodiment of the present invention;

FIG. 5 is a simplified plan view of HOI's application to Cache/Memory with VCSEL drivers, pin diode receivers, pulse generator, and a digital signal analyzer in accordance with an embodiment of the present invention;

FIG. 6 is a simplified plan view of HOI's application to semiconductor wafers in accordance with an embodiment of the present invention; and

FIG. 7 is a simplified plan view of HOI's application to mass storage in accordance with an embodiment of the present invention.

### DETAILED DESCRIPTION OF THE DRAWINGS

In the following detailed description, reference is made to the accompanying drawings that show, by way of illustration, specific embodiments in which the embodiments may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

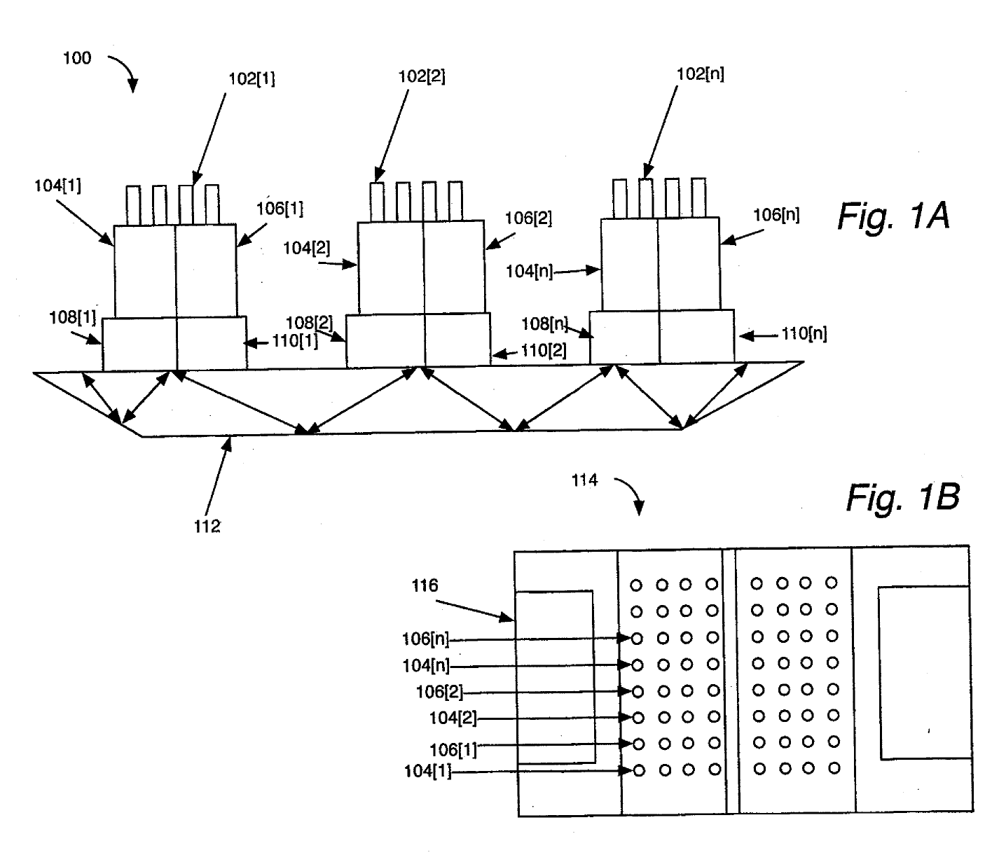

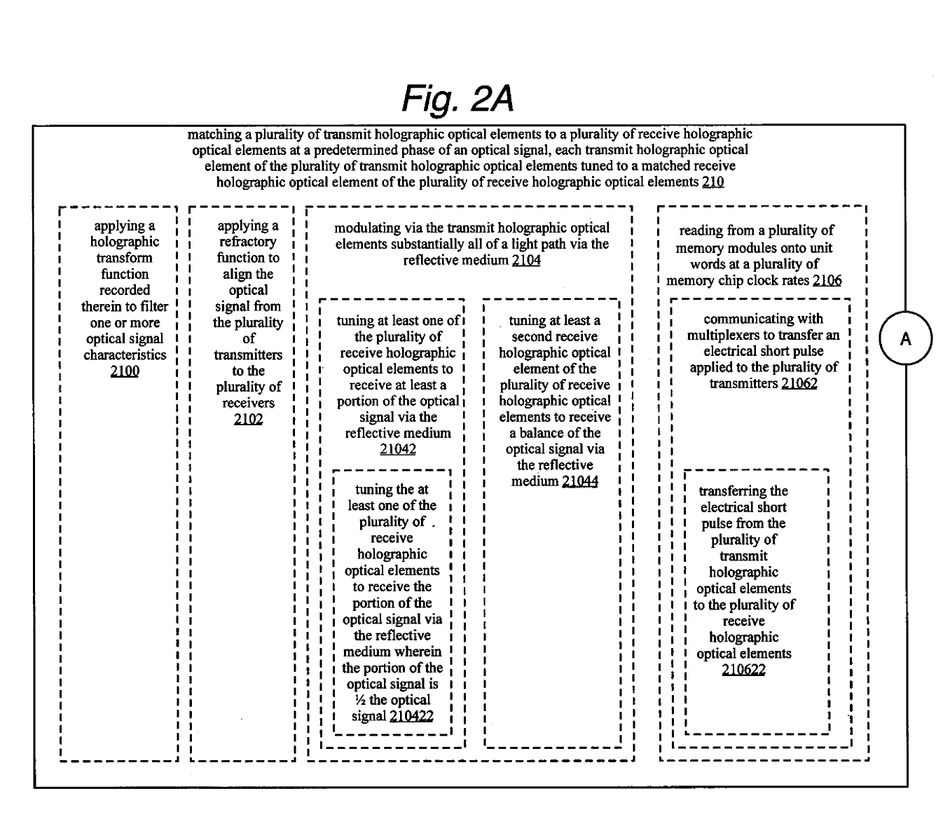

In particular, FIG. 1A depicts a simplified plan view of the holographic optical interleave system and method employing free space according to an embodiment. FIG. 1 includes computer boards 102[1-n]; vertical-cavity surface-emitting lasers (VCSELs) 104[1-n]; pin diode receivers 106[1-n]; holographic optical elements (HOE) 108[1-n] and 110[1-n]; and a reflective medium 112. The computer boards 102[1-n] are in electrical communication with the VCSELs 104[1-n]; and pin diode receivers 106[1-n]. The plurality of receivers 106[1-n] detects the optical signal from the plurality of VCSELs 104[1-n] via a reflective medium 112.

The holographic optical interleave system and method provides for matching a plurality of transmit holographic optical elements to a plurality of receive holographic optical elements at a predetermined phase of an optical signal, each transmit holographic optical element of the plurality of transmit holographic optical elements tuned to a matched receive holographic optical element of the plurality of receive holographic optical elements. The plurality of VCSELs 104[1-n] are matched with a plurality of pin diode receivers 106[1-n] to a predetermined phase of an optical signal via a plurality of VCSEL HOEs 108[1-n] and a plurality of receive HOEs 110[1-n]. Each VCSEL HOE 108[1-n] is tuned to a matched received HOE 110[1-n], respectively, which allows the received HOEs 110[1-n] to sense the optical signal from the VCSEL HOEs 108[1-n].

The VCSELs 104[1-n] and pin diode receivers 106[1-n] employ holographic optical elements (HOEs) 108[1-n] and 110[1-n], respectively. The VCSEL HOEs 108[1-n] and receive HOEs 110 [1-n] provides for applying a holographic transform function recorded therein to filter one or more optical signal characteristics and applying a refractory function to align the optical signal from the plurality of transmitters to the plurality of receivers. Thus, the VCSEL HOEs 108[1-n] and receive HOEs 110[1-n] filter and refract optical channels of communication via a reflective medium 112.

The VCSEL HOEs 108[1-n]-108[n] provides for modulating via the transmit holographic optical elements substantially all of a light

path via the reflective medium 112. The modulating via the transmit holographic optical elements substantially all of a light path via the reflective medium provides for tuning at least one of the plurality of receive holographic optical elements to receive at least a portion of the optical signal via the reflective medium 112. The modulating via the transmit holographic optical elements substantially all of a light path via the reflective medium further provides for tuning at least a second receive holographic optical element of the plurality of receive holographic optical elements to receive a balance of the optical signal via the reflective medium 112. The tuning for at least one of the plurality of receive holographic optical elements provides for tuning the at least one of the plurality of receive holographic optical elements to receive the portion of the optical signal via the reflective medium wherein the portion of the optical signal is ½ the optical signal. Then the holographic optical interleave system and method provides for organizing the plurality of transmitters and the plurality of receivers to receive the optical signal via a reflective medium coupled to the plurality of receivers. Finally, the holographic optical interleave system and method provides for directing the optical signal via the reflective medium from each transmit holographic optical element tuned to the associated receive holographic optical element. Specifically, the optical signal is directed to the plurality of receive HOEs 110[1-n], which is tuned with the associated plurality of VCSEL HOEs 108[1-n].

Referring to FIG. 1A and 1B, one or more optical channels facilitate communication between VCSEL HOEs 108[1-n] and receive HOEs 110[1-n] via a reflective medium 112. One optical channel includes one or more VCSELs 104[1-n] mounted to computer board 102[1-n], one or more pin diode receivers 106[1-n] mounted to computer board 102[1-n], which is in data communication with VCSEL 104[1-n]. Although FIG. 1A depicts a number of computer boards, FIG. 1A is only one embodiment of a configuration within the scope described herein, which will be appreciated by those of skill in the art with the benefit of the present disclosure. VCSEL 104[1-n] that is mounted to computer board 102[1-n] is matched with the pin diode receiver 106[1-n] that is mounted to computer board 102[1-n] to a predetermined phase of an optical signal via a VCSEL HOE 108[1-n] and a receive HOE 110[1-n]. The VCSEL HOE 108[1-n] is tuned to an associated receive HOE 110[1-n], which allows the receive HOE 110[1-n] to sense the optical signal from the VCSEL HOE 108[1-n] via a reflective medium 112. Each VCSEL HOE 108[1-n] and receive HOE 110[1-n] has both a refractory function and a holographic transform function enabling VCSEL HOE 108[1-n] and receive HOE 110 [1-n] to concurrently filter and refract the optical signal passing therethrough.

VCSEL HOE 108[1-n] and receive HOE 110[1-n] can be configured to be identical in construction. VCSEL HOE 108[1-n] and receive HOE 110[1-n] have a refractory lens with a bulk hologram recorded therein that defines a holographic transform function. The holographic transform function only allows specific wavelengths and/or certain polarizations of optical energy to pass through the lens, while diffracting unwanted wavelengths and polarizations away from pin diode receiver 106[1-n].

Optical channel communication between VCSEL HOE 108[1-n] and receive HOE 110[1-n] is facilitated via a reflective medium 112, which increases the bandwidth for communication. FIG. 1B illustrates a top view 114 of VCSEL drivers and pin diode receivers 104 and 106 and provides free space optical channel 116. The free space optical channel 116 enables the advancement to terabyte backplane operation.

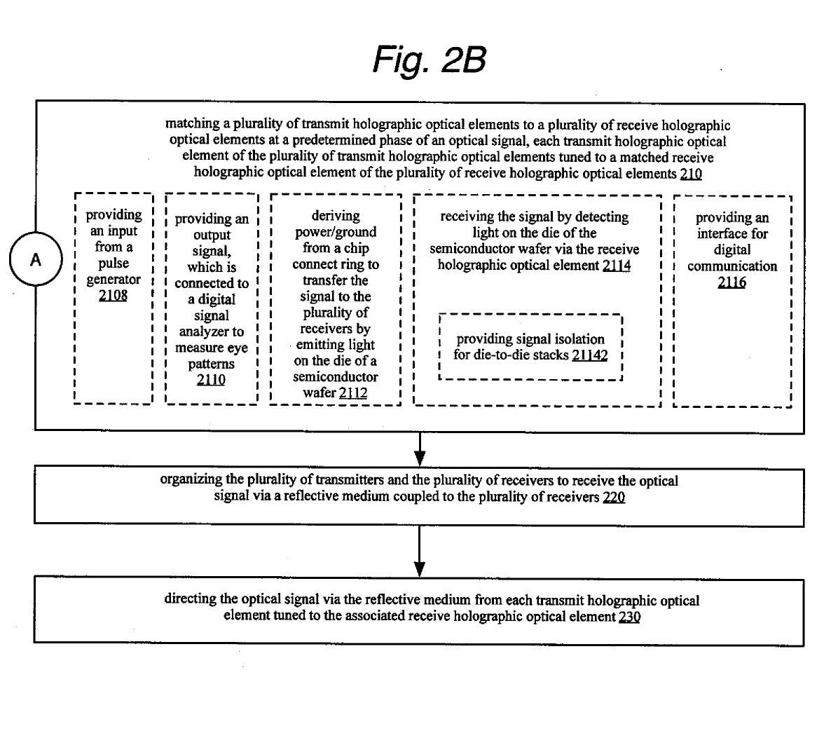

FIG. 2A and 2B represents a flow diagram that illustrates a method for receiving the optical signal in accordance with an embodiment. Block 210 provides for matching a plurality of transmit holographic optical elements to a plurality of receive holographic optical elements at a predetermined phase of an optical signal, each transmit holographic optical element of the plurality of transmit holographic optical elements tuned to a matched receive holographic optical element of the plurality of receive holographic optical elements. As explained in FIG. 1A, a plurality of VC SELs 104 [1-n] are matched with a plurality of pin diode receivers 106[1-] to a predetermined phase of an optical signal via a plurality of VCSEL HOEs 108[1-n]-108[n] and a plurality of receive HOEs 110[1-n]. Each VCSEL HOE 108[1-n] is tuned to a matched received HOE 110[1-n], respectively, which allows the received HOEs 110[1-n] to sense the optical signal from the VCSEL HOEs 108[1-n].

Depicted within block 210 is optional block 2100, which provides for applying a holographic transform function recorded therein to filter one or more optical signal characteristics. The holographic transform function only allows specific wavelengths or certain polarization of optical energy to pass through the lens, while diffracting unwanted wavelengths and polarizations away from pin diode receiver 106[1-n].

Block 210 further includes optional block 2102, which provides for applying a refractory function to align the optical signal from the plurality of transmitters to the plurality of receivers. The refractory function enables VCSEL HOE 108[1-n] and receive HOE 110[1-n] to align the optical signal passing through.

Block 210 further includes optional block 2104, which provides for modulating via the transmit holographic optical elements substantially all of a light

path via the reflective medium. Depicted within optional block 2104 are optional blocks 21042 and 21044. The modulating via the transmit holographic optical elements substantially all of a light

path via the reflective medium, in optional block 2104, can include tuning at least one of the plurality of receive holographic optical elements to receive at least a portion of the optical signal via the reflective medium in optional block 21042, The modulating via the transmit holographic optical elements substantially all of a light

path via the reflective medium, in optional block 2104, can further include tuning at least a second receive holographic optical element of the plurality of receive holographic optical elements to receive a balance of the optical signal via the reflective medium in optional block 21044.

Depicted within optional block 21042 is optional block 210422. The tuning at least one of the plurality of receive holographic optical elements to receive at least a portion of the optical signal via the reflective medium, in optional block 21042, can include tuning the at least one of the plurality of receive holographic optical elements to receive the portion of the optical signal via the reflective medium wherein the portion of the optical signal is ½ the optical signal in block 210422.

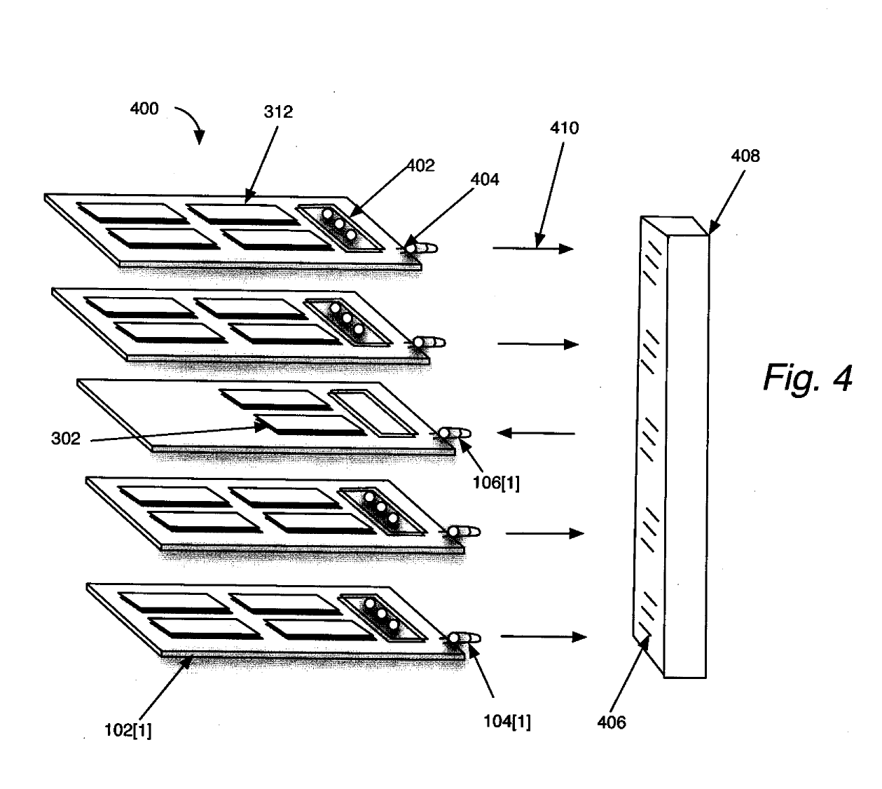

Block 210 further includes optional block 2106, which provides for reading from a plurality of memory modules onto unit words at a plurality of memory chip clock rates. Depicted within optional block 2106 is optional block 21062, which provides for communicating with multiplexers to transfer an electrical short pulse applied to the plurality of transmitters. Depicted within optional block 21062 is optional block 210622. The communicating with multiplexers to transfer an electrical short pulse applied to the plurality of transmitters, in optional block 21062, can include transferring the electrical short pulse from the plurality of transmit holographic optical elements to the plurality of receive holographic optical elements in optional block 210622. Thus, for example, the memory modules 312 are time offset & interleaved, with bits collected by HOI based “Local bus” onto unit words at multiples of memory chip clock rates. In FIG. 4, memory modules 312 electrically communicate with multiplexers 402 to transfer an electrical short pulse 404 applied to VCSEL 104[1-n]. VCSEL 104[1-n] transfers the optical short pulse 410 to the volume hologram 406. The volume hologram 406 then transfers the optical short pulse 410 to pin diode receiver 106[1-n], which is mounted on the same computer board 102[1-n] of the CPU 302. CPU 302 registers the speed at eight GB at fifty ps access memory module.

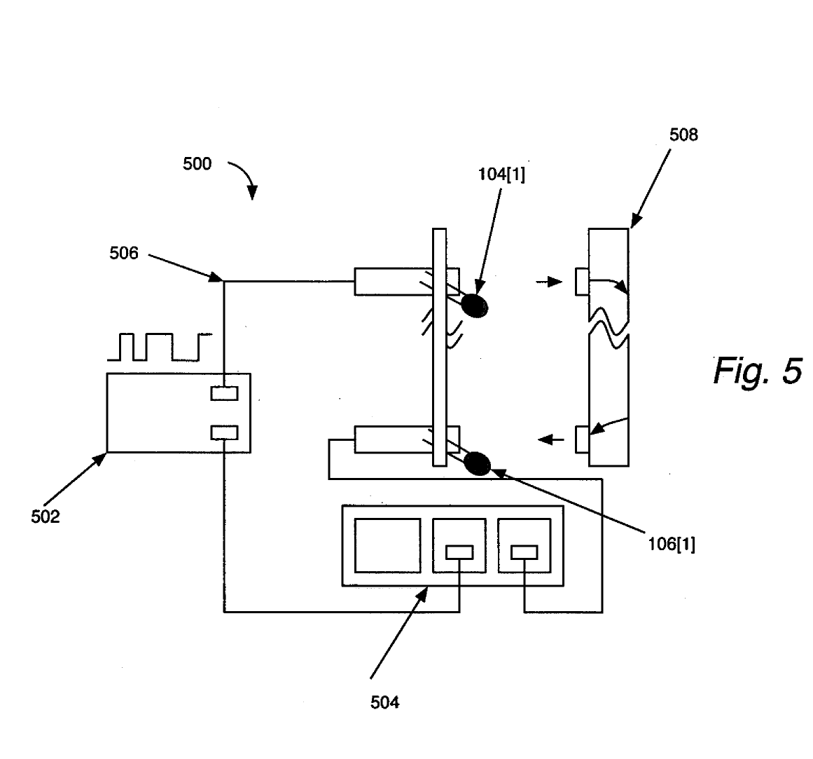

Block 210 further includes optional blocks 2108 and 2110 as illustrated in FIG. 2B. Optional block 2108 provides for providing an input from a pulse generator and optional block 2110 provides for providing an output signal connected to a digital signal analyzer to measure eye patterns. Thus, for example, the pseudo-random bit sequence (PBRS) 506 from a pulse generator 502 is used as the input of VCSEL driver 104[1-n] in an optoelectronic interface module. The output signal is transferred through the optical waveguiding plate with volume holographic grating 508 and the pin diode receiver 106[1-n] detects the signal in the optoelectronic interface module. Along with the trigger signal from the pulse generator 502, the output signal from the pin diode receiver 106[1-n] is fed into a digital communication analyzer 504 to measure eye patterns as illustrated in FIG. 5. The result justifies that these optoelectronic interface modules are capable of supporting high speed processing elements.

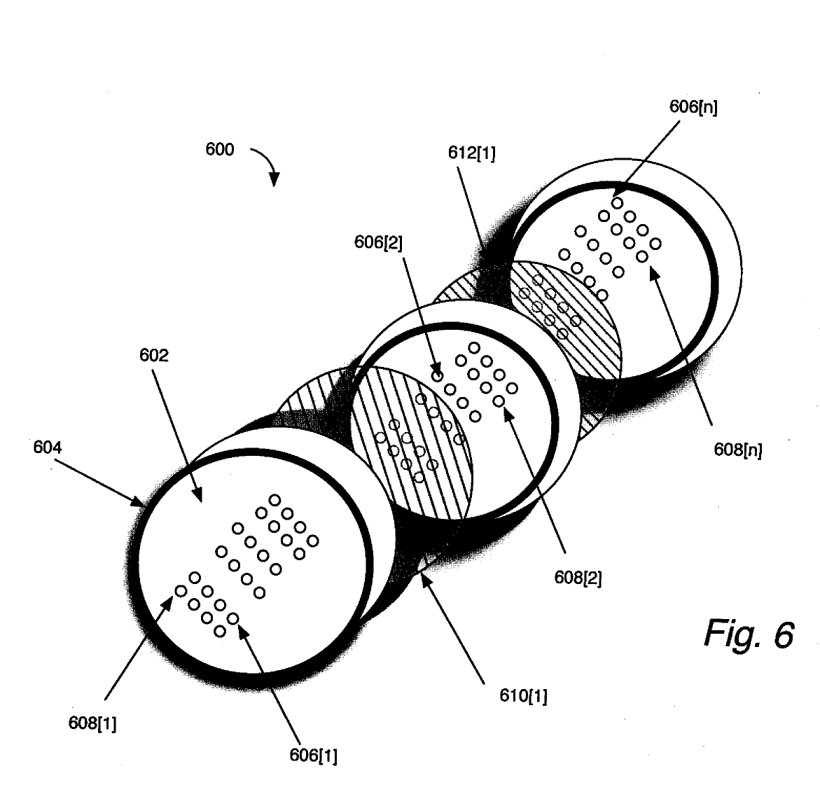

Block 210 further includes optional block 2112 and 2114 as illustrated in FIG. 2B. Optional block 2112 provides for deriving power/ground from a chip connect ring to transfer the signal to the plurality of receivers by emitting light on the die of a semiconductor wafer. Optional block 2114 provides for receiving the signal by detecting light on the die of the semiconductor wafer via the receive holographic optical element. Depicted within optional block 2114 is optional block 21142, which provides for providing signal isolation for die-to-die stacks. Thus, for example, the VCSELs 606[1-n]-606[n] derive power/ground from a chip connect ring 604 to emit light on the die of a semiconductor wafer 602 to transfer a signal as illustrated in FIG. 6. The pin diode receivers 608[1-n]-608[n] detect light on the die of the semiconductor wafer 602 to receive the signal. The VCSEL 606[1-n] is matched with the pin diode receiver 608[1-n] to a predetermined phase of an optical signal via a VCSEL HOE 610[1-n] and a receive HOE 612[1-n]. VCSEL HOE 610[1-n] and receive HOE 612[1-n] provides signal isolation for die-to-die stacks.

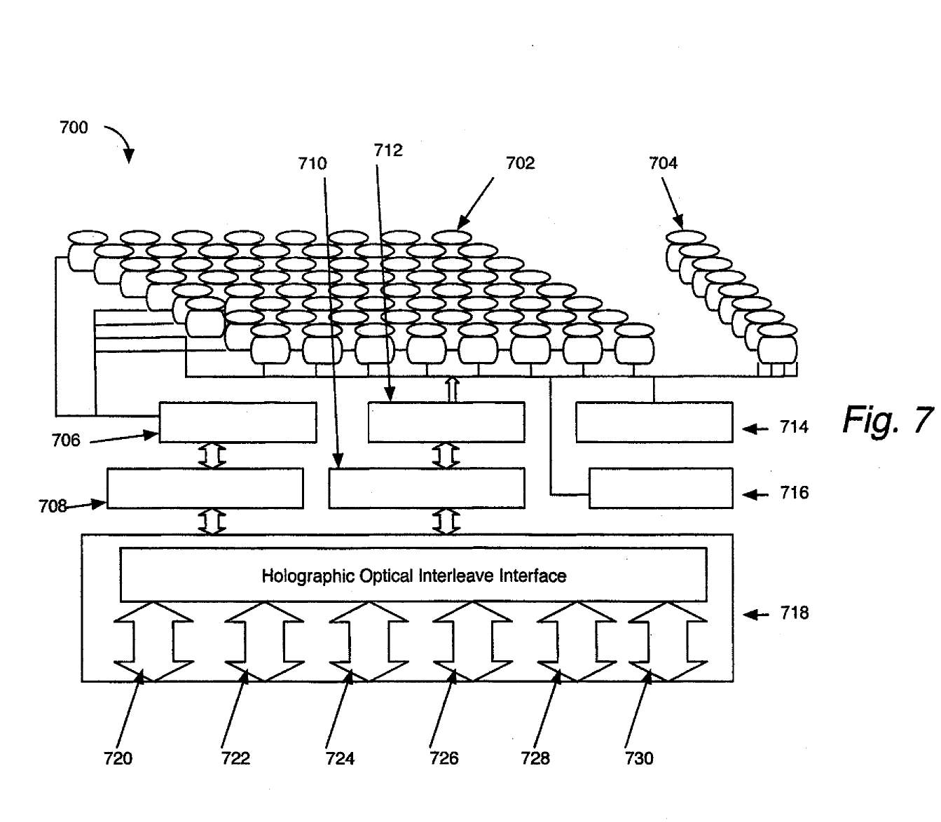

Block 210 further includes optional block 2116, which provides for providing an interface for digital communication as illustrated in FIG. 2B. For instance, HOI provides an interface 718 for digital communication between Ethernet 720, fibre channel 722, optical cables 724, PCI-X 726, hyper-transport 728, and free space optics 730 with SCSI to Advanced Technology Attachment (ATA) Command/Status Parser and Translator 708 and Unified Data Cache Memory 710 as illustrated in FIG. 7.

Block 220 provides for organizing the plurality of transmitters and the plurality of receivers to receive the optical signal via a reflective medium coupled to the plurality of receivers. Block 230 provides for directing the optical signal via the reflective medium from each transmit holographic optical element tuned to the associated receive holographic optical element. Specifically, the optical signal is directed to the plurality of receive HOEs 110[1-n]-110[n], which is tuned with the associated plurality of VCSEL HOEs 108[1-n]-108[n].

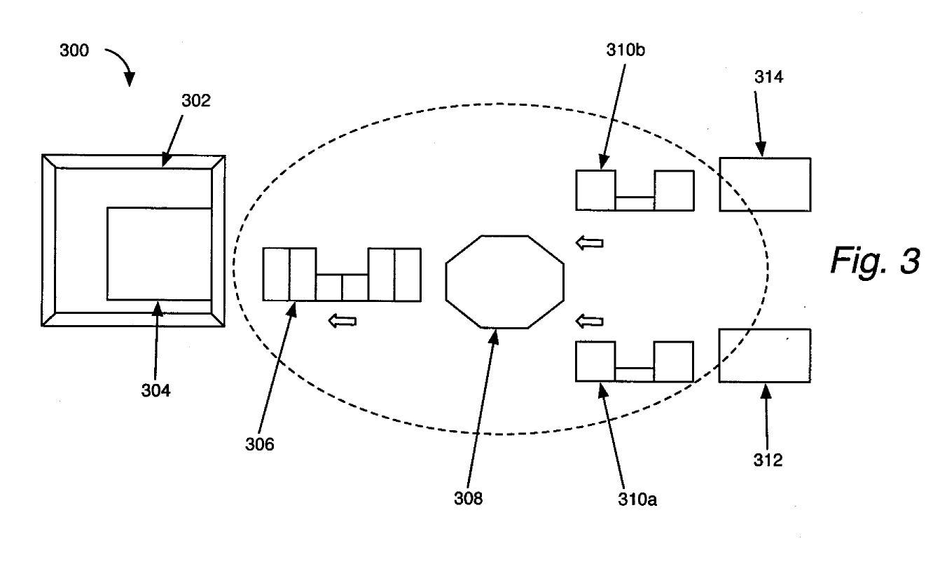

FIGS. 3, 4 and 5 illustrate different embodiments for employing a cache/memory system utilizing the holographic optical interleave system and method in accordance with an embodiment. FIG. 3 illustrates the incorporation of the holographic optical interleave system and method to memory modules. Specifically, memory modules 312 and 314 send data, i.e, 533 mega bits per second (Mbps), to the main Hub 308, which transfer the data at a faster rate, i.e., 1066 Mbps, to cache 304 within the Central Processing Unit (CPU) 302. The application of HOI to cache/memory allows the integration of eight memory chips at a HOI times eight rate. In addition, the application enables the system to employ a 1 gigabyte (GB) at 200 pulses per second (pps) access memory module and an eight GB at 50 pps access memory module.

FIG. 4 depicts how the Hub 308 in FIG. 3 operates to enable faster communication between memory modules 312 and the CPU 302. FIG. 4 illustrates that the optical layer 408 and volume hologram 406 read from multiple memory modules 312. Memory modules 312 are time offset and interleaved, with bits collected by an HOI-based local bus onto unit words at multiples of memory chip clock rates. In FIG. 4, memory modules 312 electriconically communicate with multiplexers 402 to transfer an electrical short pulse 404 applied to VCSELs 104[1-n]. VCSEL 104[1-n] transfers the optical short pulse 410 to the volume hologram 406. The volume hologram 406 then transfers the optical short pulse 410 to pin diode receiver 106[1-n], which is mounted on the same computer board 102[1-n] of the CPU 302. CPU 302 registers the speed at eight GB at 50 pps access memory module.

FIG. 5 depicts how the pseudo-random bit sequence (PBRS) 506 from a pulse generator 502 is used as the input of VCSEL driver 104[1-n] in an optoelectronic interface module. The output signal is transferred through the optical waveguiding plate with volume holographic grating 508; pin diode receiver 106[1-n] detects the signal in the optoelectronic interface module. Along with the trigger signal from pulse generator 502, the output signal from the pin diode receiver 106[1-n] is fed into a digital communication analyzer 504 to measure eye patterns. The resulting optoelectronic interface modules are capable of supporting high speed processing elements.

FIG. 6 depicts how HOI can be applied to Chip/Die Stacks. The VCSELs 606[1-n]-606[n] derive power/ground from a chip connect ring 604 to emit light on the die of a semiconductor wafer 602 to transfer a signal. The pin diode receivers 608[1-n]-608[n] detect light on the die of the semiconductor wafer 602 to receive the signal. The VCSEL 606[1-n] is matched with the pin diode receiver 608[1-n] to a predetermined phase of an optical signal via a VCSEL HOE 610[1-n] and a receive HOE 612[1-n]. VCSEL HOE 610[1-n] and receive HOE 612[1-n] provide signal isolation for die-to-die stacks.

FIG. 7 depicts HOI's application to mass storage 700, which can be implemented as a plurality of hard disk drives, optical storage devices, or other type of data memory system for storing digital data such as floppy disks, flash memory, magneto-optical discs, Drum memory, magnetic tape, punched tape and holographic memory. HOI provides an interface 718 for digital communication between Ethernet 720, fibre channel 722, optical cables 724, PCI-X 726, hyper-transport 728, and free space optics 730 with SCSI to Advanced Technology Attachment (ATA) Command/Status Parser and Translator 708 and Unified Data Cache Memory 710. HOI's application to mass storage enables the use of commercial controllers that have HOI enabled backplanes.

Although specific embodiments of the invention have been described and illustrated, the invention is not to be limited to the specific forms or arrangements of parts so described and illustrated. The invention is limited only by the claims.

Those with skill in the computing arts will recognize that the disclosed embodiments have relevance to a wide variety of applications and architectures in addition to those described above. In addition, the functionality of the subject matter of the present application can be implemented in software, hardware, or a combination of software and hardware. The hardware portion can be implemented using specialized logic; the software portion can be stored in a memory or recording medium and executed by a suitable instruction execution system such as a microprocessor.

While the subject matter of the application has been shown and described with reference to particular embodiments thereof, it will be understood by those skilled in the art that the foregoing and other changes in form and detail may be made therein without departing from the spirit and scope of the subject matter of the application, including but not limited to additional, less or modified elements and/or additional, less or modified blocks performed in the same or a different order.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Those skilled in the art will recognize that it is common within the art to implement devices and/or processes and/or systems in the fashion(s) set forth herein, and thereafter use engineering and/or business practices to integrate such implemented devices and/or processes and/or systems into more comprehensive devices and/or processes and/or systems. That is, at least a portion of the devices and/or processes and/or systems described herein can be integrated into comprehensive devices and/or processes and/or systems via a reasonable amount of experimentation. Those having skill in the art will recognize that examples of such comprehensive devices and/or processes and/or systems might include—as appropriate to context and application—all or part of devices and/or processes and/or systems of (a) an air conveyance (e.g., an airplane, rocket, hovercraft, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Quest, Southwestern Bell, etc.); or (g) a wired/wireless services entity such as Sprint, Cingular, Nextel, etc.), etc.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., ” a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., ” a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

We claim:

1. A method for providing a backplane using a holographic optical interleave, the method comprising:
matching a plurality of transmit holographic optical elements to a plurality of receive holographic optical elements at a predetermined phase of an optical signal, each transmit holographic optical element of the plurality of transmit holographic optical elements tuned to a matched receive holographic optical element of the plurality of receive holographic optical elements;
organizing the plurality of transmitters and the plurality of receivers to receive the optical signal via a reflective medium coupled to the plurality of receivers; and
directing the optical signal via the reflective medium from each transmit holographic optical element tuned to the associated receive holographic optical element.

2. The method of claim 1, wherein the matching a plurality of transmit holographic optical elements to a plurality of receive holographic optical elements at a predetermined phase of an optical signal, each transmit holographic optical element of the plurality of transmit holographic optical elements tuned to a matched receive holographic optical element of the plurality of receive holographic optical elements includes:
applying a holographic transform function recorded therein to filter one or more optical signal characteristics; and
applying a refractory function to align the optical signal from the plurality of transmitters to the plurality of receivers.

3. The method of claim 1, wherein the matching a plurality of transmit holographic optical elements to a plurality of receive holographic optical elements at a predetermined phase of an optical signal, each transmit holographic optical element of the plurality of transmit holographic optical elements tuned to a matched receive holographic optical element of the plurality of receive holographic optical elements includes:
modulating via the transmit holographic optical elements substantially all of a light path via the reflective medium.

4. The method of claim 3, wherein the modulating via the transmit holographic optical elements substantially all of a light
path via the reflective medium includes:
tuning at least one of the plurality of receive holographic optical elements to receive at least a portion of the optical signal via the reflective medium; and
tuning at least a second receive holographic optical element of the plurality of receive holographic optical elements to receive a balance of the optical signal via the reflective medium.

5. The method of claim 4, wherein the tuning at least one of the plurality of receive holographic optical elements to receive at least a portion of the optical signal via the reflective medium includes:
tuning the at least one of the plurality of receive holographic optical elements to receive the portion of the optical signal via the reflective medium wherein the portion of the optical signal is ½ the optical signal.

6. The method of claim 1, wherein the matching a plurality of transmit holographic optical elements to a plurality of receive holographic optical elements at a predetermined phase of an optical signal, each transmit holographic optical element of the plurality of transmit holographic optical elements tuned to a matched receive holographic optical element of the plurality of receive holographic optical elements further includes:
reading from a plurality of memory modules onto unit words at a plurality of memory chip clock rates.

7. The method of claim 6, wherein the reading from a plurality of memory modules onto unit words at a plurality of memory chip clock rates includes:
communicating with multiplexers to transfer an electrical short pulse applied to the plurality of transmitters.

8. The method of claim 7, wherein the communicating with multiplexers to transfer an electrical short pulse applied to the plurality of transmitters includes:
transferring the electrical short pulse from the plurality of transmit holographic optical elements to the plurality of receive holographic optical elements.

9. The method of claim 1, wherein the matching a plurality of transmit holographic optical elements to a plurality of receive holographic optical elements at a predetermined phase of an optical signal, each transmit holographic optical element of the plurality of transmit holographic optical elements tuned to a matched receive holographic optical element of the plurality of receive holographic optical elements further includes:
providing an input from a pulse generator; and
providing an output signal connected to a digital signal analyzer to measure eye patterns.

10. The method of claim 1, wherein the matching a plurality of transmit holographic optical elements to a plurality of receive holographic optical elements at a predetermined phase of an optical signal, each transmit holographic optical element of the plurality of transmit holographic optical elements tuned to a matched receive holographic optical element of the plurality of receive holographic optical elements further includes:
deriving power/ground from a chip connect ring to transfer the signal to the plurality of receivers by emitting light on the die of a semiconductor wafer; and
receiving the signal by detecting light on the die of the semiconductor wafer via the receive holographic optical element.

11. The method of claim 10, wherein the receiving the signal by detecting light on the die of the semiconductor wafer via the receive holographic optical element includes:
providing signal isolation for die-to-die stacks.

12. The method of claim 1, wherein the matching a plurality of transmit holographic optical elements to a plurality of receive holographic optical elements at a predetermined phase of an optical signal, each transmit holographic optical element of the plurality of transmit holographic optical elements tuned to a matched receive holographic optical element of the plurality of receive holographic optical elements further includes:
providing an interface for digital communication.

13. A method for enhancing a computer backplane employing free space, the method comprising:
matching a plurality of transmit holographic optical elements to a plurality of receive holographic optical elements at a predetermined phase of an optical signal, each transmit holographic optical element of the plurality of transmit holographic optical elements tuned to a matched receive holographic optical element of the plurality of receive holographic optical elements;
organizing the plurality of transmitters and the plurality of receivers to receive the optical signal via a reflective medium coupled to the plurality of receivers and the plurality of receivers; and
enabling the computer backplane to employ free space by directing the optical signal via the reflective medium from each transmit holographic optical element tuned to the associated receive holographic optical element.

14. An apparatus comprising:
a computer board;
a plurality of transmitters having a source of an optical signal;
a plurality of receivers aligned on a same plane as the plurality of transmitters to receive the optical signal;
a plurality of holographic optical elements aligned in the same plane, each having a holographic transform function imposed thereon to filter one or more characteristics of the optical signal and a refractory function to align the optical signal from the plurality of transmitters to the plurality of receivers; and
a reflective medium to direct the optical signal back to the plane.

15. The apparatus of claim 14, wherein the plurality of transmitters having a source of an optical signal are vertical-cavity surface emitting lasers and the plurality of receivers aligned on a same plane as the plurality of transmitters to receive the optical signal are pin diode receivers mounted to the computer board.

16. The apparatus of claim 14, wherein the plurality of transmitters having a source of an optical signal and the plurality of receivers aligned on a same plane as the plurality of transmitters to receive the optical signal are connected via short electrical leads to current to voltage converters on the computer board.

17. The apparatus of claim 14, wherein plurality of holographic optical elements aligned in the same plane, each having a holographic transform function imposed thereon to filter one or more characteristics of the optical signal and a refractory function to align the optical signal from the plurality of transmitters to the plurality of receivers includes:
an optical layer and volume hologram configured to read from a plurality of memory modules onto unit words at a plurality of memory chip clock rates.

18. The apparatus of claim 17, wherein the plurality of memory modules electrically communicate with multiplexers to transfer an electrical short pulse applied to the plurality of transmitters.

19. The apparatus of claim 18, wherein the plurality of memory modules electrically communicate with multiplexers to transfer an electrical short pulse applied to the plurality of transmitters includes:
means for transfering the electrical short pulse from the plurality of transmit holographic optical elements to the plurality of receive holographic optical elements.

20. The apparatus of claim 14, wherein the plurality of transmitters having a source of an optical signal and the plurality of receivers aligned on a same plane as the plurality of transmitters to receive the optical signal includes:
means for receiving an input from a pulse generator; and
means for receiving an output signal connected to a digital signal analyzer to measure eye patterns.

21. The apparatus of claim 14, wherein the plurality of transmitters having a source of an optical signal and the plurality of receivers aligned on a same plane as the plurality of transmitters to receive the optical signal includes:
a chip connect ring that provides power/ground to transfer the signal to the plurality of receivers by emitting light on the die of a semiconductor wafer; and
a receiver configured to detect light on the die of the semiconductor wafer via the receive holographic optical element.

22. The apparatus of claim 21, wherein the receiver configured to detect light on the die of the semiconductor wafer via the receive holographic optical element includes:
signal isolation for die-to-die stacks.

23. The apparatus of claim 14, wherein the plurality of holographic optical elements aligned in the same plane, each having a holographic transform function imposed thereon to filter one or more characteristics of the optical signal and a refractory function to align the optical signal from the plurality of transmitters to the plurality of receivers includes:
an interface for digital communication.
